(19) United States
(12) Patent Application Publication
(10) Pub. No.: US 2008/0189106 A1
(43) Pub. Date: Aug. 7, 2008

(54) Multi-Stage Speech Recognition System

(76) Inventors: Andreas Low, Neu-Ulm (DE); Joachim Grill, Ulm (DE)

Correspondence Address: BRINKS HOFER GILSON & LIONE, P.O. BOX 10395, CHICAGO, IL, 60610, US

(21) Appl. No.: 11/957,883

(22) Filed: Dec. 17, 2007

(30) Foreign Application Priority Data
Dec. 21, 2006 (EP) 06026600.4

(51) Int. Cl. G10L 15/00

(52) U.S. Cl. 704/231; 704/E15.001

(57) ABSTRACT

A multi-stage speech recognition system includes an audio transducer that detects a speech signal, and a sampling circuit that converts the transducer output into a digital speech signal. A spectral analysis circuit identifies a portion of the speech signal corresponding to a first class and a second class. The system includes memory storage or a database having a first and a second vocabulary list. A recognition circuit recognizes the first class based on the first vocabulary list to obtain a first recognition result. A matching circuit restricts a vocabulary list based on the first recognition result, and a recognizing circuit recognizes the second class based on the restricted vocabulary list, to obtain a second recognition result.

### PRIORITY CLAIM

This application claims the benefit of priority from European Patent Application No. 06 02 6600.4, filed Dec. 21, 2006, which is incorporated by reference.

### BACKGROUND OF THE INVENTION

1. Technical Field

This disclosure relates to speech recognition. In particular, this disclosure relates to a multi-stage speech recognition system and control of devices based on recognized words or commands.

2. Related Art

Some speech recognition systems may incorrectly recognize spoken words due to time variations in the input speech. Other speech recognition systems may incorrectly recognize spoken words because of orthographic or phonetic similarities of words. Such systems may not consider the content of the overall speech, and may not distinguish between words having orthographic or phonetic similarities

### SUMMARY

A multi-stage speech recognition system includes an audio transducer that detects a speech signal, and a sampling circuit that converts the transducer output into a digital speech signal. A spectral analysis circuit identifies a portion of the speech signal corresponding to a first class and a second class. The system includes memory storage or a database having a first and a second vocabulary list. A recognition circuit recognizes the first class based on the first vocabulary list to obtain a first recognition result. A matching circuit restricts a vocabulary list based on the first recognition result, and a recognizing circuit recognizes the second class based on the restricted vocabulary list, to obtain a second recognition result.

Other systems, methods, features, and advantages will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 is a multi-stage speech recognition system.

FIG. 2 is a recognition pre-processing system.

FIG. 3 is a spectral analysis circuit.

FIG. 4 is a multi-stage speech recognition system in a vehicle.

FIG. 5 is a speech recognition process in a navigation system.

FIG. 6 is a speech recognition process in a media system.

FIG. 7 is a speech recognition process.

FIG. 8 is an application control process.

### DETAILED DESCRIPTION OF THE PREFERRED EMBODIMENTS

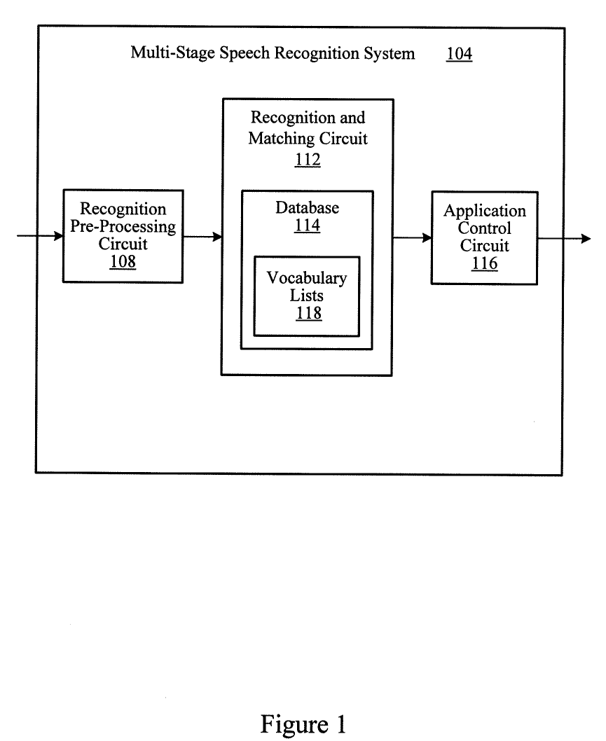

FIG. 1 is a multi-stage speech recognition system 104. The multi-stage speech recognition system 104 may include a recognition pre-processing circuit 108, a recognition and matching circuit 112, and an application control circuit 116. The recognition pre-processing circuit 108 may pre-process speech signals to generate recognized words. The recognition and matching circuit 112 may include a database 114 and may receive the recognized words and determine content or commands based on the words. The database 114 may include a plurality of vocabulary lists 118. The application control circuit 116 may control various user-controlled systems based on the commands.

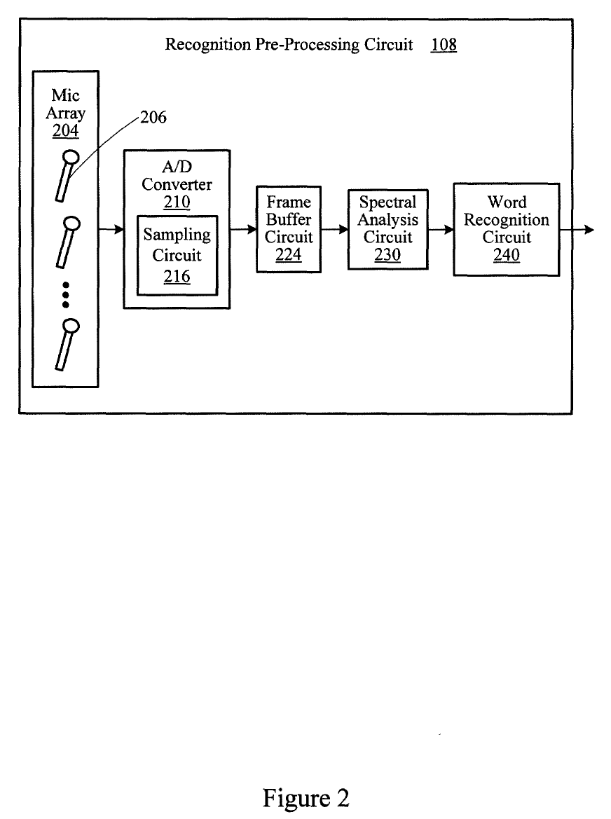

FIG. 2 is the recognition pre-processing circuit 108. The recognition pre-processing circuit 108 may include a device that converts sound or audio signals into an electrical signal. The device may be a microphone or microphone array 204 having a plurality of microphones 206 for receiving a speech signal, such as a verbal utterance issued by a user. The microphone array 204 may receive verbal utterances, such as isolated words or continuous speech.

An analog-to-digital converter 210 may convert the microphone output into digital data. The analog-to-digital converter 210 may include a sampling circuit 216. The sampling circuit 216 may sample the speech signals at a rate between about 6.6 kHz to about 20 kHz and generate a sampled speech signal. Other sampling rates may be used. The sampling circuit 216 may be part of the analog-to-digital converter 210 or may be a separate or remote component.

A frame buffer circuit 224 may receive the sampled speech signal. The sampled speech signal may be pulse code modulated and may be transformed into sets or frames of measurements or features at a fixed rate. The fixed rate may be about every 10 milliseconds to about 20 milliseconds. A single frame may include about 300 samples, and each sample may be about 20 milliseconds in duration. Other values for the number of samples per frame and sample duration may be used. Each frame and its corresponding data may be analyzed to search for probable word candidates based on acoustic, lexical, and language constraints and models.

A spectral analysis circuit 230 may process the sampled speech signal on a frame-by-frame basis. The sampled speech may be derived from the short term power spectra of the speech signal, and may represent a vector or a sequence of characterizing vectors containing values corresponding to features or feature parameters. The feature parameters may represent the amplitude of the signal in different frequency ranges, and may be used in succeeding analysis stages to distinguish between different phonemes. The feature parameters may be used to estimate a probability that the portion of the speech waveform corresponds to a particular detected phonetic event or a particular entry in memory storage, such as a word in the vocabulary list 118.

The characterizing vectors may include between about 10 and about 20 feature parameters for each frame. The characterizing vectors may be cepstral vectors. A “cepstrum” may be determined by calculating a logarithmic power spectrum, and then determining an inverse Fourier transform. A “cepstrum” of a signal is the Fourier transform of the logarithm (with unwrapped phase) of the Fourier transform, which may be referred to as a “spectrum of a spectrum.” The cepstrum may separate a glottal frequency from the vocal tract resonance.

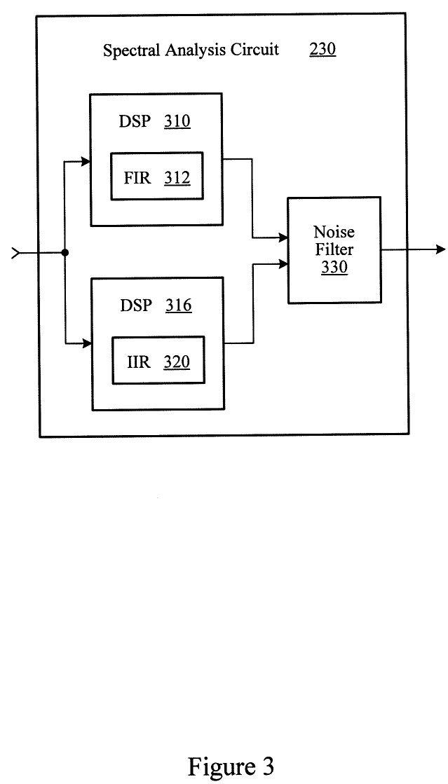

FIG. 3 is the spectral analysis circuit 230. The spectral analysis circuit 230 may include one or more digital signal processing circuits (DSP). The spectral analysis circuit 230 may include a first digital signal processing circuit 310, which may include one or more finite impulse response filters 312. The spectral analysis circuit 230 may include a second digital signal processing circuit 316, which may include one or more infinite impulse response filters 320. A noise filter 330 may noise reduce the output of the first and/or second digital signal processing circuits 310 and 316.

The recognition pre-processing circuit 108 of FIG. 2 may include a word recognition circuit 240. The word recognition circuit 240 may receive input from the spectral analysis circuit 230 and may form a concatenation of allophones that may constitute a linguistic word. Allophones may be represented by Hidden Markov Models that may be characterized by a sequence of states, where each state may have a well-defined transition probability. To recognize a spoken word, the word recognition circuit 240 may determine the most likely sequence of states through the Hidden Markov Model. The word recognition circuit 240 may calculate the sequence of states using a Viterbi process, which may iteratively determine a most likely path. Hidden Markov Models may represent a dominant recognition paradigm with respect to phonemes. The Hidden Markov Model may be a double stochastic model where the generation of underlying phoneme strings and frame-by-frame surface acoustic representations may be represented probabilistically as a Markov process. Other models may be used, such as an acoustic model, grammar model and combinations of the above models.

The recognition and matching circuit 112 of FIG. 1 may further process the output from the recognition pre-processing circuit 108. The processed speech signal may contain information corresponding to different parts of speech. Such parts of speech may correspond to a number of classes, such as genus names, species names, proper names, country names, city names, artists' names, and other names. A vocabulary list may contain the identified parts of speech. A separate vocabulary list may be used to facilitate the recognition of each part of the speech signal or class. The vocabulary lists 118 may be part of the database 114. The speech signal may include at least two phonemes, each of which may be referred to a class. The term “word” or “words” may mean “linguistic words” or sub-units of linguistic words, which may be characters, syllables, consonants, vowels, phonemes, or allophones (context dependent phonemes). The term “sentence” may mean a sequence of linguistic words. The multi-stage speech recognition system 104 may process a speech signal based on isolated words or based on continuous speech.

A sequence of recognition candidates may be based on the characterizing vectors, which may represent the input speech signal. Sequence recognition may be based on the results from a set of alternative suggestions (“string hypotheses), corresponding to a string representation of a spoken word or a sentence. Individual string hypotheses may be assigned a “score.” The string hypotheses may be evaluated according to one or more predetermined criteria with respect to the probability that the hypotheses correctly represent the verbal utterance. A plurality of string hypotheses may represent an ordered set or sequence according to a confidence measure of the individual hypotheses. For example, the string hypotheses may constitute an “N” best list, such as a vocabulary list. Ordered “N” best lists may be efficiently processed.

In some systems, acoustic features of phonemes may be used to determine a score. For example, an “s” may have a temporal duration of more than 50 milliseconds, and may exhibit frequencies above about 44 kHz. Frequency characterization of the phonemes may be used to derive rules for statistical classification. The score may represent a distance measure indicating how “far” or how “close” a characterizing vector is to an identified phoneme, which may provide an accuracy measure for the associated word hypothesis. Grammar models using syntactic and semantic information may be used to assign a score to individual string hypotheses, which may represent linguistic words.

The use of scores may improve the accuracy of the speech recognition process by accounting for the probability of mistaking one of the list entries for another. Utilization of two different criteria, such as the score and the probability of mistaking one hypothesis for another hypothesis, may improve speech recognition accuracy. For example, the probability of mistaking an “f” for an “n” may be a known probability based on empirical results. In some systems, a score may be given a higher priority than the probability of mistaking a particular string hypothesis. In other systems, the probability of mistaking a particular string hypothesis may be given a higher priority than the associated score.

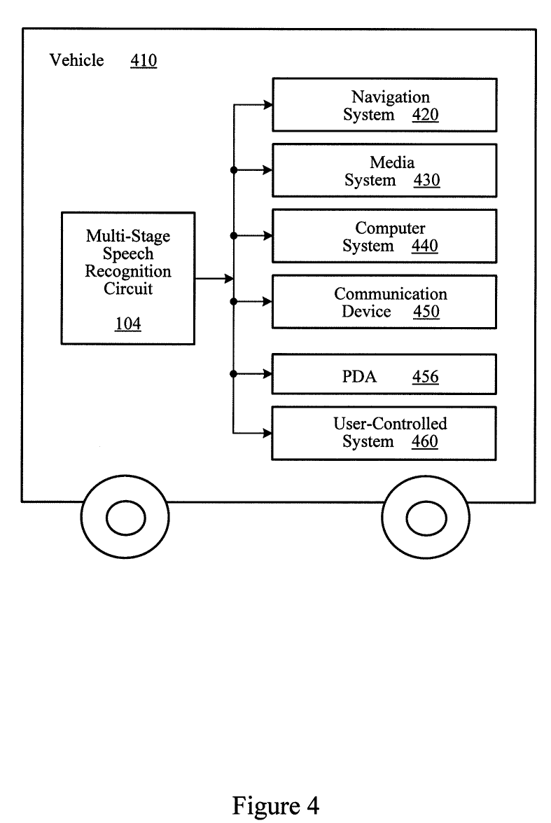

FIG. 4 is the multi-stage speech recognition system 104 in a vehicle or vehicle environment 410. The multi-stage speech recognition system 104 may control a navigation system 420, a media system 430, a computer system 440, a telephone or other communication device 450, a personal digital assistant (PDA) 456, or other user-controlled system 460. The user-controlled systems 460 may be in the vehicle environment 410 or may be in a non-vehicle environment. For example, the multi-stage speech recognition system 104 may control a media system 430, such as an entertainment system in a home. The multi-stage speech recognition system 104 may be separate from the user-controlled systems 460 or may be part of the user-controlled system.

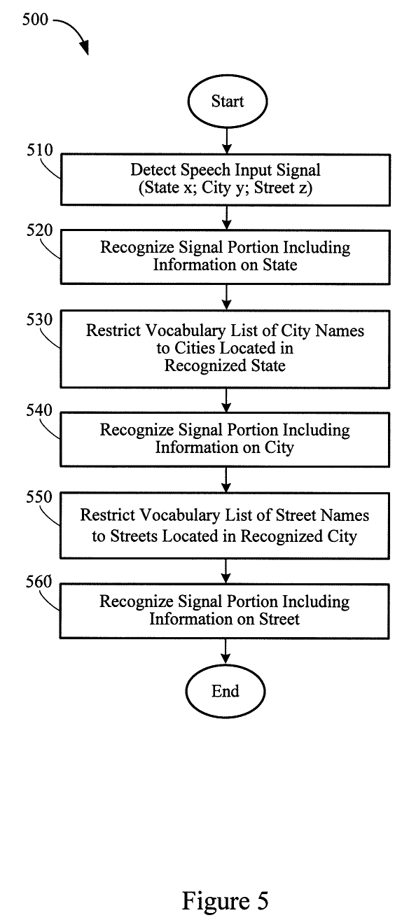

FIG. 5 is a speech recognition process (Act 500) that may be used with the vehicle navigation system 420 or other system to be controlled using verbal commands. The navigation system 420 may respond to verbal commands, such as commands having a destination address. Based on the destination address, the navigation system 420 may display a map and guide the user to the destination address.

The user may say the name of a state “x,” a city name “y,” and a street name “z” (Act 510) as part of an input speech signal. The name of the state may first be recognized (Act 520). A vocabulary list of all city names stored in the database 114 or in a database of the navigation system 420 may be restricted to entries that refer only to cities located in the recognized state (Act 530). The portion of the input speech signal corresponding to the name of the city “y” may be processed for recognition (Act 540) based on the previously restricted vocabulary list of city names, which may be a subset of city names corresponding to cities located in the recognized state. Based on the recognized city name, a vocabulary list having street names may be restricted to street names corresponding to streets located in the recognized city (Act 550). From the restricted list of street names, the correct entry corresponding to the spoken street name “z” may be identified (Act 560).

The portions of the input speech signal may be identified by pauses in the input speech signal. In some processes, such portions of the input speech signal may be introduced by using keywords that may be recognized.

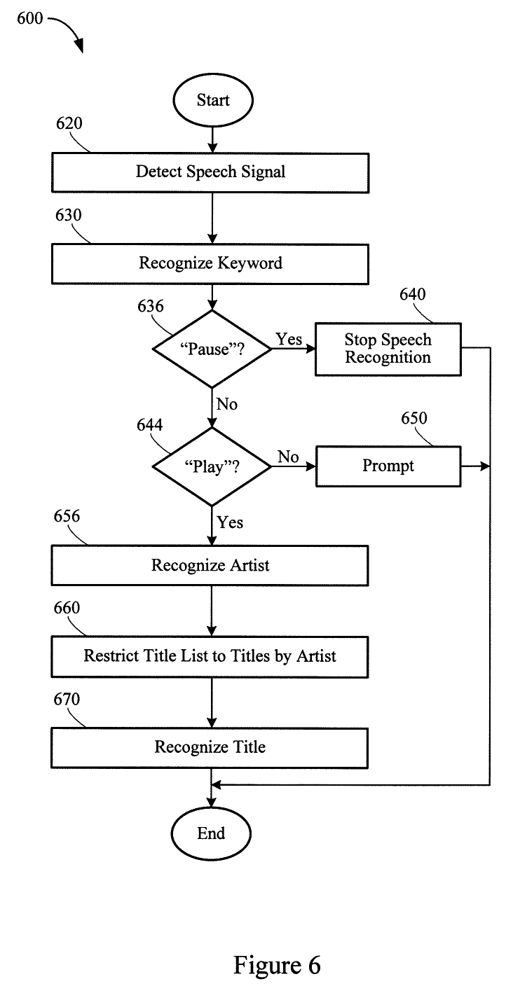

FIG. 6 is a word recognition process (Act 600) that may be used with a media system 430 or other system to be controlled using verbal commands. The media system 430 may respond to verbal commands (Act 620). The user may say the name of an artist or title of a song as part of an input speech signal. The key word may be recognized (Act 630). The media system 430 may be, for example, a CD player, DVD player, MP3 player, or other user-controlled system 460 or media-based device or system.

Recognition may be based on keywords that may be identified in the input speech signal. For example, if a keyword such as “pause,” “halt,” or “stop” is recognized (Act 636), the speech recognition process may be stopped (Act 640). If no such keywords are recognized, the input speech signal may be checked for the keyword “play” (Act 644). If neither the keyword “pause” (nor halt” nor “stop”) nor the keyword “play” is recognized, recognition processing may be halted, and the user may be prompted for additional instructions (Act 650).

If the keyword “play” is recognized, the speech signal may be further processed to recognize an artist name (Act 656), which may be included in the input speech signal. A vocabulary list may be generated containing the “N” best recognition candidates corresponding to the name of the artist. The input speech signal may have the following format: “play”<song title> “by”<artist's name>. A vocabulary list may include various artists, and may be smaller than a vocabulary list that includes various titles of songs, because the titles of songs may be a subset of a corresponding artist name. Recognition processing may be based first on a smaller generated vocabulary list. Based on the recognition result, a larger vocabulary list may then be restricted (Act 660). A restricted vocabulary list corresponding to song titles of the recognized artist name may be generated, which may represent the “N” best song titles. After the list has been restricted, recognition processing may identify the appropriate song title (Act 670).

For example, a vocabulary list for an MP3 player may contain 20,000 or more song titles. According to the above process, the vocabulary list for song titles may be reduced to a sub-set of song titles corresponding to the recognized “N” best list of artists. The value of “N” may vary depending upon the application. The multi-stage speech recognition system 104 may avoid or reduce recognition ambiguities in the user's input speech signal because the titles of songs by artists whose names are not included in the “N” best list of artists may be excluded from processing. The speech recognition process 600 may be performed by generating the “N” best lists based on cepstral vectors. Other models may be used for generating the “N” best lists of recognition candidates corresponding to the input speech signal.

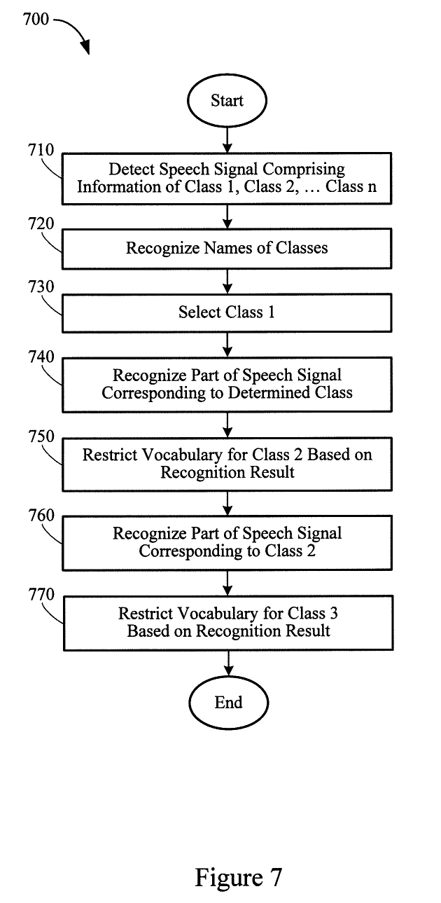

FIG. 7 is a generalized word recognition process (Act 700). The recognition pre-processing circuit 108 may process an input speech signal (Act 710) and identify various words or classes (Act 720). Each word or class may have an associated vocabulary list. In some systems, the names of the classes may be city names and street names. Class No. 1 may then be selected for processing (Act 730). The information from the input speech signal corresponding to class 1 may be linked to or associated with a vocabulary list having the smallest size relative to the other vocabulary lists (Act 740). The next class may then be analyzed, which may correspond to the next smallest vocabulary list relative to the other vocabulary lists. The class may be denoted as class No. 2. Based on the previous recognition result, the vocabulary list corresponding to class 2 may be restricted (Act 750) prior to recognizing the semantic information of class 2. Based on the restricted vocabulary list, the class may be recognized (Act 760).

The process of restricting vocabulary lists and identifying entries of the restricted vocabulary lists may be iteratively repeated for all classes, until the last class (class n) is processed (Act 770). The multi-stage process 700 may allow for relatively simple grammar in each speech recognition stage. Each stage of speech recognition may follow the preceding stage without intermediate user prompts. Complexity of the recognition may be reduced by the iterative restriction of the vocabulary lists. For some of the stages, sub-sets of the vocabulary lists may be used.

The multi-stage speech recognition system 104 may efficiently process an input speech signal. Recognition processing for each of the portions (words, phonemes) of an input speech signal may be performed using a corresponding vocabulary list. In response to the recognition result for a portion of the input speech signal, the vocabulary list used for speech recognition for a second portion of the input speech signal may be restricted in size. In other words, a second stage recognition processing may be based on a sub-set of the second vocabulary list rather than on the entire second vocabulary list. Use of restricted vocabulary lists may increase recognition efficiency. The multi-stage speech recognition system 104 may process a plurality of stages, such a between about two to about five or more stages. For each stage, a different vocabulary list may be used, which may be restricted in size based on the recognition result from a preceding stage. This process may be efficient when the first vocabulary list contains fewer entries than the second or subsequent vocabulary list because in the first stage processing, the entire vocabulary list may be checked to determine the best matching entry, whereas in the subsequent stages, processing may be based on the restricted vocabulary lists.

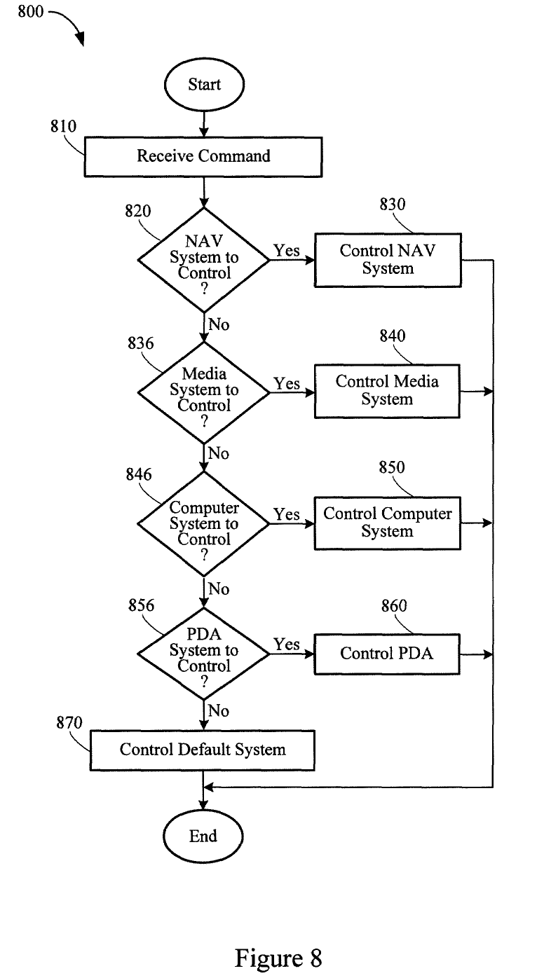

FIG. 8 is a process for application control (Act 800). The application control process may receive a command (Act 810) from the application control circuit 116 to control a particular system or device. If the command received corresponds to the navigation system 420 (Act 820), the navigation system 420 may be controlled to implement the command (Act 830). The navigation system 420 may be controlled to display a map, plot a path, compute driving distances, or perform other functions corresponding to the navigation system 420. If the command received corresponds to the media system 430 (Act 836), the media system 430 may be controlled to implement the corresponding command (Act 840). The media system 430 may be controlled to play a song of a particular artist, play multiple songs, pause, skip a track, or perform other functions corresponding to the media system 430.

If the command received corresponds to the computer system 440 (Act 846), the computer system 440 may be controlled to implement the command (Act 850). The computer system 440 may be controlled to implement any functions corresponding to the computer system 440. If the command received corresponds to the PDA system 456 (Act 856), the PDA system may be controlled to implement the command (Act 860). The PDA system 456 may be controlled to display an address or contact, a telephone number, a calendar, or perform other functions corresponding to the navigation system 420. If the command received does not correspond to the enumerated systems, a default or non-specified system may be controlled to implement the command, if applicable (Act 870).

The logic, circuitry, and processing described above may be encoded in a computer-readable medium such as a CDROM, disk, flash memory, RAM or ROM, an electromagnetic signal, or other machine-readable medium as instructions for execution by a processor. Alternatively or additionally, the logic may be implemented as analog or digital logic using hardware, such as one or more integrated circuits (including amplifiers, adders, delays, and filters), or one or more processors executing amplification, adding, delaying, and filtering instructions; or in software in an application programming interface (API) or in a Dynamic Link Library (DLL), functions available in a shared memory or defined as local or remote procedure calls; or as a combination of hardware and software.

The logic may be represented in (e.g., stored on or in) a computer-readable medium, machine-readable medium, propagated-signal medium, and/or signal-bearing medium. The media may comprise any device that contains, stores, communicates, propagates, or transports executable instructions for use by or in connection with an instruction executable system, apparatus, or device. The machine-readable medium may selectively be, but is not limited to, an electronic, magnetic, optical, electromagnetic, or infrared signal or a semiconductor system, apparatus, device, or propagation medium. A non-exhaustive list of examples of a machine-readable medium includes: a magnetic or optical disk, a volatile memory such as a Random Access Memory “RAM,” a Read-Only Memory “ROM,” an Erasable Programmable Read-Only Memory (i.e., EPROM) or Flash memory, or an optical fiber. A machine-readable medium may also include a tangible medium upon which executable instructions are printed, as the logic may be electronically stored as an image or in another format (e.g., through an optical scan), then compiled, and/or interpreted or otherwise processed. The processed medium may then be stored in a computer and/or machine memory.

The systems may include additional or different logic and may be implemented in many different ways. A controller may be implemented as a microprocessor, microcontroller, application specific integrated circuit (ASIC), discrete logic, or a combination of other types of circuits or logic. Similarly, memories may be DRAM, SRAM, Flash, or other types of memory. Parameters (e.g., conditions and thresholds) and other data structures may be separately stored and managed, may be incorporated into a single memory or database, or may be logically and physically organized in many different ways. Programs and instruction sets may be parts of a single program, separate programs, or distributed across several memories and processors. The systems may be included in a wide variety of electronic devices, including a cellular phone, a headset, a hands-free set, a speakerphone, a communication interface, or an infotainment system.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A multi-stage recognition method for recognizing a speech signal containing semantic information of two or more classes, comprising:
detecting and digitizing the speech signal;
providing a database having at least one vocabulary list for each class;
recognizing a portion of the speech signal corresponding to a first class based on a vocabulary list corresponding to the first class, to obtain a first recognition result;
restricting a vocabulary list corresponding to a second class based on the first recognition result; and
recognizing a portion of the speech signal corresponding to the second class based upon the restricted vocabulary list, to obtain a second recognition result.

2. The method of claim 1, where the vocabulary list corresponding to the first class contains fewer entries than the vocabulary list corresponding to the second class.

3. The method of claim 1, where the semantic information of the first class is detected later than the semantic information of the second class.

4. The method of claim 1, where recognition for each class and restricting the respective vocabulary lists are performed for all of the classes in the speech signal.

5. The method of claim 1, where recognizing the portion of the speech signal corresponding to the first class and/or second class comprises generating an “N” best list of recognition candidates selected from the respective vocabulary lists.

6. The method of claim 5, where generating the “N” best list comprises assigning a score to each entry of the respective vocabulary lists.

7. The method of claim 6, where the score is assigned based on a predetermined probability of mistaking one entry for another entry.

8. The method of claim 6, where the scores are determined based on an acoustic model probability.

9. The method of claim 6, where the scores are determined based on a Hidden Markov Model.

10. The method of claim 6, where the scores are determined based on a grammar model probability.

11. The method of claim 1, further comprising:
dividing the speech signal into a plurality of frames; and
determining at least one characterizing vector for each frame.

12. The method of claim 11, where the characterizing vector comprises a spectral content of the speech signal.

13. The method of claim 11, where the characterizing vector comprises a cepstral vector.

14. The method of claim 1, where the first class corresponds to a city name and the first recognition result identifies the city name; and
the second class corresponds to a street name and the second recognition result identifies the street name.

15. The method of claim 1, where
a) the first class corresponds to an artist name and the first recognition result identifies the artist name; and
b) the second class corresponds to a song title and the second recognition result identifies the song title.

16. The method of claim 1, where
a) the first class corresponds to a name of a person and the first recognition result identifies the name of a person; and
b) the second class corresponds to an address or telephone number and the second recognition result identifies the address or telephone number.

17. A computer-readable storage medium having processor executable instructions to perform multi-stage recognition of a speech signal containing semantic information of two or more classes, by performing the acts of:
detecting and digitizing the speech signal;
providing a database having at least one vocabulary list for each class;
recognizing a portion of the speech signal corresponding to a first class based on a vocabulary list corresponding to the first class, to obtain a first recognition result;
restricting a vocabulary list corresponding to a second class based on the first recognition result; and
recognizing a portion of the speech signal corresponding to the second class based upon the restricted vocabulary list, to obtain a second recognition result.

18. The computer-readable storage medium of claim 17, further comprising processor executable instructions to cause a processor to perform the act of detecting the semantic information of the first class later than detecting the semantic information of the second class.

19. The computer-readable storage medium of claim 17, further comprising processor executable instructions to cause a processor to perform the acts of recognizing each class and restricting the respective vocabulary lists for all of the classes in the speech signal.

20. The computer-readable storage medium of claim 17, further comprising processor executable instructions to cause a processor to perform the acts of generating an “N” best list of recognition candidates selected from the respective vocabulary lists.

21. A system for multi-stage speech recognition, comprising:
an audio transducer configured to detect a speech signal;
a sampling circuit configured to digitize the detected speech signal;
a database configured to store at least a first and a second vocabulary list;
a spectral analysis circuit configured to identify a portion of the speech signal corresponding to a first class and a second class;
a recognition circuit configured to recognize the first class based on the first vocabulary list to obtain a first recognition result;
a matching circuit configured to restrict at least one vocabulary list other than the first vocabulary list, based on the first recognition result; and
the recognizing circuit configured to recognize the second class based on the restricted vocabulary list, to obtain a second recognition result.

22. The system of claim 21, further comprising:
a navigation system;
an application control circuit configured to control the navigation system; and where the application control circuit receives commands based on the first and second recognition results and controls the navigation system based on the received commands.

23. The system of claim 21 further comprising:
a media system;
an application control circuit configured to control the media system; and where the application control circuit receives commands based on the first and second recognition results and controls the media system based on the received commands.

24. The system of claim 21, further comprising:
a user-controlled device;
an application control circuit configured to control the user-controlled device; and where
the application control circuit receives commands based on the first and second recognition results and controls the user-controlled device based on the received commands.
